(19) United States
(12) Patent Application Publication
(10) Pub. No.: US 2011/0270660 A1
(43) Pub. Date: Nov. 3, 2011

(54) Software platform

(75) Inventors: John Bettioi, Austin, TX (US); Jay Valanju, Austin, TX (US)

(73) Assignee: Fisoc, Inc.

(21) Appl. No.: 13/066,763

(22) Filed: Apr. 25, 2011

Related U.S. Application Data
(60) Provisional application No. 61/343,257, filed on Apr. 26, 2010.

(51) Int. Cl. G06Q 30/00

(52) U.S. Cl. 705/14.25; 705/14.1

(57) ABSTRACT

A software platform is provided. The software platform includes a rewards component; a banking component; and a social media component. The software platform further includes input from banks and other financial institutions. The rewards component includes a processor, a transaction filter, a rewards filter, and a social filter. The social filter connects to social media sites. The rewards component uses input from the banking component to determine rewards and the social media component uses input from consumer transactions, financial products and offers to output to social media websites. The output to social media websites may be location based information, feeds or mobile phone based services. The user data is determined by the use of the banking component and/or the social media component. The rewards component provides financial incentives based on data from the user.

### CROSS-REFERENCE TO RELATED APPLICATIONS

This application claims the benefit of U.S. Provisional application Ser. No. ______ filed ______, the contents of which is incorporated herein by reference.

### BACKGROUND OF THE INVENTION

The present application relates to software platforms, and in particular to software platforms that interact with merchants, users and social media.

### BRIEF DESCRIPTION OF THE DRAWINGS

The objects and features of the present invention will be described in the Detailed Description below, which is intended to be read in conjunction with the following set of drawings, in which:

FIGS. 1 and 1a depict high level view of the software platform;

FIGS. 2, 2a, 2b, 2c, 2d depict Product/FI/Partner Value Creation;

FIGS. 3 and 3a depict the reward product;

FIG. 4 depicts a High Level Process Flow;

FIG. 5 depicts a Hybridized Content Delivery Process;

FIG. 6 is a Diagram of How content is processed and handled including local or remote;

FIGS. 7, 7a and 7b depict the Action, Reaction, Suggestion and Analysis Platform;

FIGS. 8 and 8a further depict the Action, Reaction, Suggestion and Analysis Platform;

FIG. 9 further depicts the Action, Reaction, Suggestion and Analysis Platform; and

FIGS. 10 and 10a depict Automated Inline Anonymization Transport Mechanism.

### DETAILED DESCRIPTION OF THE PREFERRED EMBODIMENTS

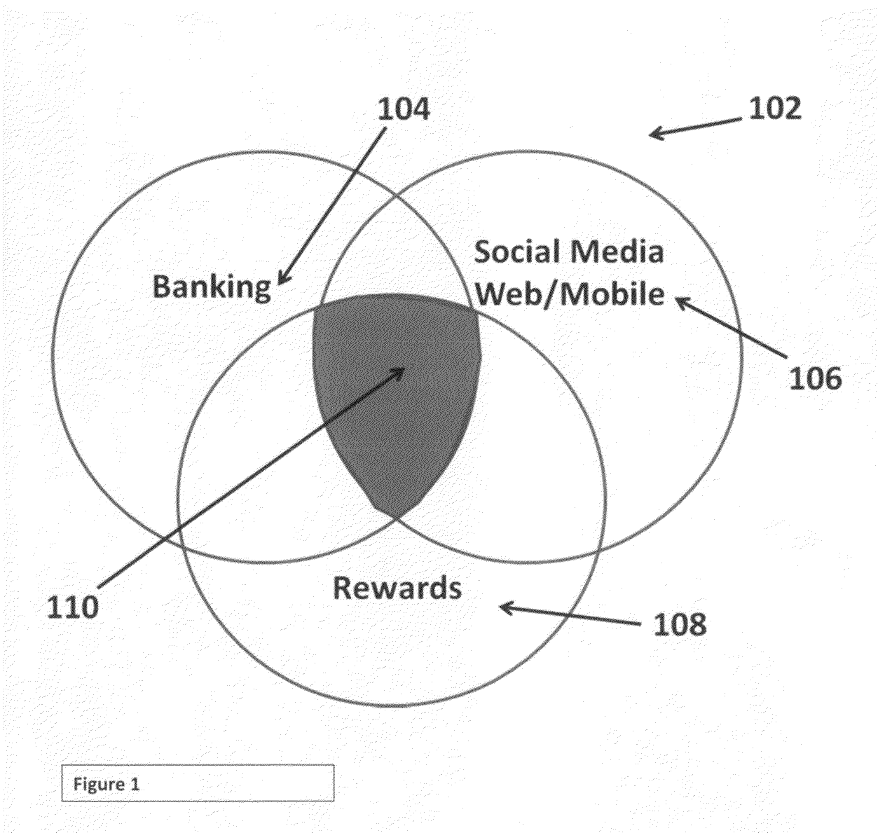

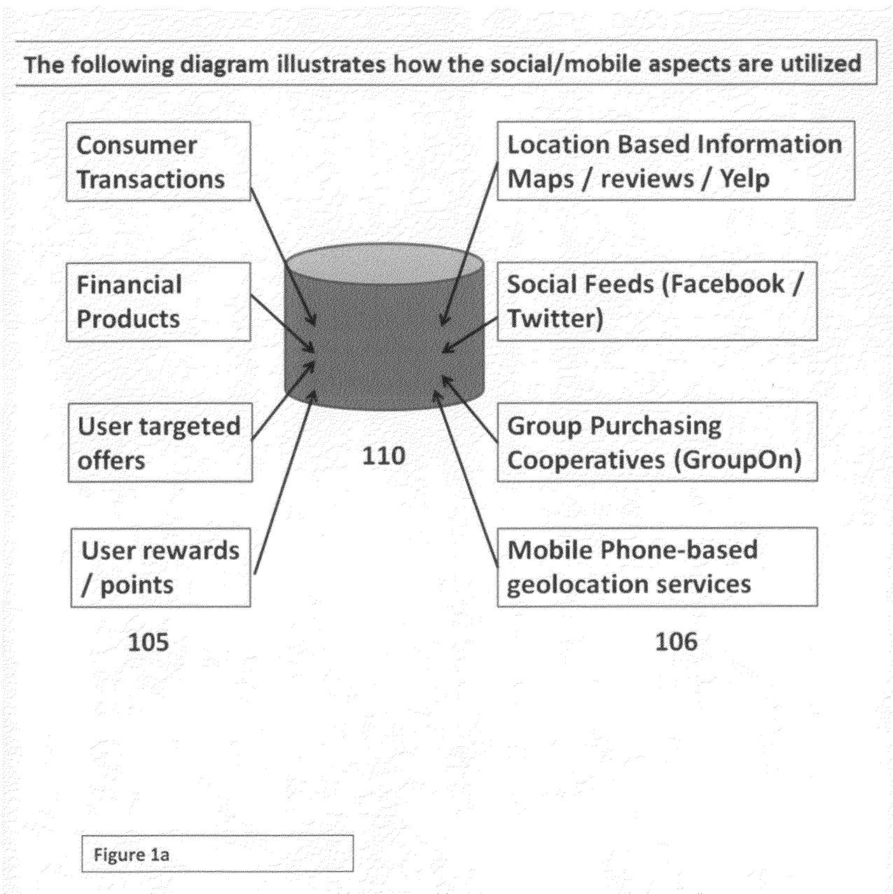

Reference is now made to FIG. 1, which depicts the high level view of the Fisoc Life software platform 102 and each subcomponent. The rewards component 108 contains the Action, Reaction, Suggestion and Analysis Platform. The Action, Reaction, Suggestion and Analysis Platform is the core component of platform 102. The Action, Reaction, Suggestion and Analysis Platform imports Banking Data and Facebook and social media and networking data. It then associates between different connections (banks, Facebook, PayPal, Wal-Mart) and differentiates between Actions and State related data. It also then allows actions and state information to then be processed by the Rewards component of the Life product. The Suggestion and Reaction components are what is used to allocate rewards points to consumers based on their actions.

The Banking component 104 contains the Automated Inline Anonymization Transport Mechanism. This is an automated mechanism to ensure data is anonymized before transfer from a financial institution to our servers. The banking component 104 also contains the Hybridized Content Delivery Process. This is a software mechanism that allows Financial Institutions to provide an authentication and customized portal for the customers that can run on the platform 110. It is used for customer login (and validating their anonymized credentials) and also for directly accessing a reskinned version of the bank that resides on our portal.

The Social Media Component 106 contains the Facebook Life bridge. This allows Facebook user information to be imported into the platform 110 as part of Life State, Entry and Associations (see Action, Reaction, Suggestion and Analysis Platform).

The banking component 104 is a group of mechanisms that allow financial institutions to surface their products to applicable users. Examples of this are Checking Accounts, Credit Cards, Direct Debit Cards, Deposits, Insurance Proposals, and Credit Reports. For all of these products, the financial institution has the ability to provide rewards points. Examples are Points per transaction, Points per application, Points per good behavior,

The social media/web/mobile component 106 is the section of the platform that facilitates interaction between the user, the users networks (social websites/mobile phone contact lists/user forums) and third parties (the software platform acts as a conduit between the parties). The user has access to a feed which illustrates their entire history within the system. Each feed item has the potential to be connected to many different social services (that provide further information about any feed item) and in turn it also has the ability to then be broadcast out to social services that have their own feed (Facebook/Twitter).

The rewards component 108 of the platform analyzes a user's activities and allocates rewards point/coupons/cash based on whether there are rule sets permitting points/coupons/cash for said activities.

FIG. 1a shows how the social media web/mobile 106 aspects are utilized. The transactions 105 are input into the platform 110. This information is linked from the platform and fed to items such as location based information, social feeds, croup purchasing cooperatives and mobile phone based geological services.

108 is the Product Value for Consumers. Under the Passive Rewards/Achievements Program, users do not need to visit site to maintain points (they only need to visit to see their balance or redeem gifts/cash/coupons). Points are based on types of transactions, transaction groups. Points are based on transaction region (locations/buildings), points are based on user activities/achievements, points based on user interaction with 3rd parties (applications).

Integration with social partners to refer new customers who receive points for referrals. Deals offered to users based on user's profile (their interests and activities). Deals are also offered to users from commercial entities such as loyalty programs for changing customer behavior.

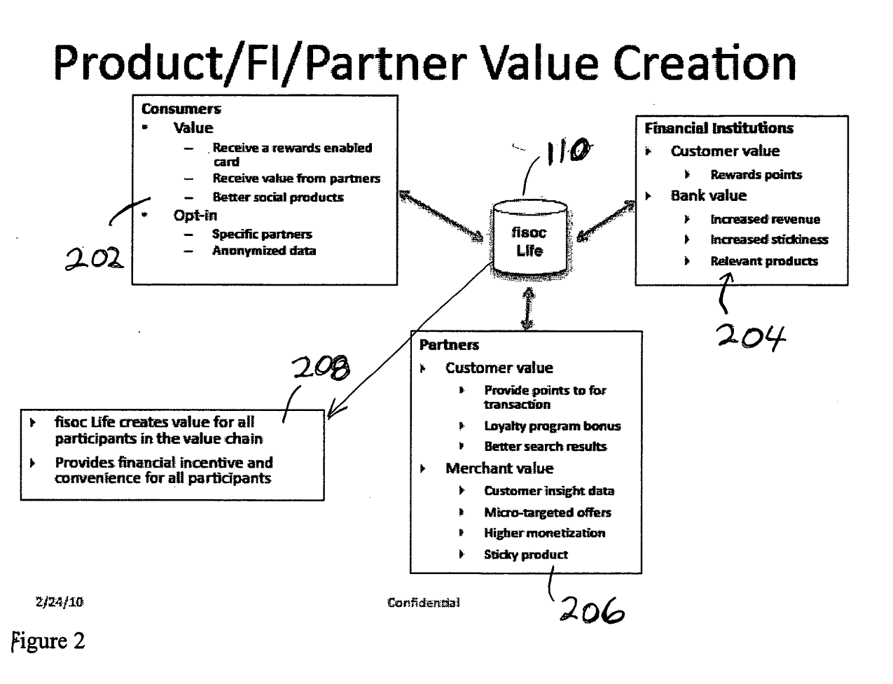

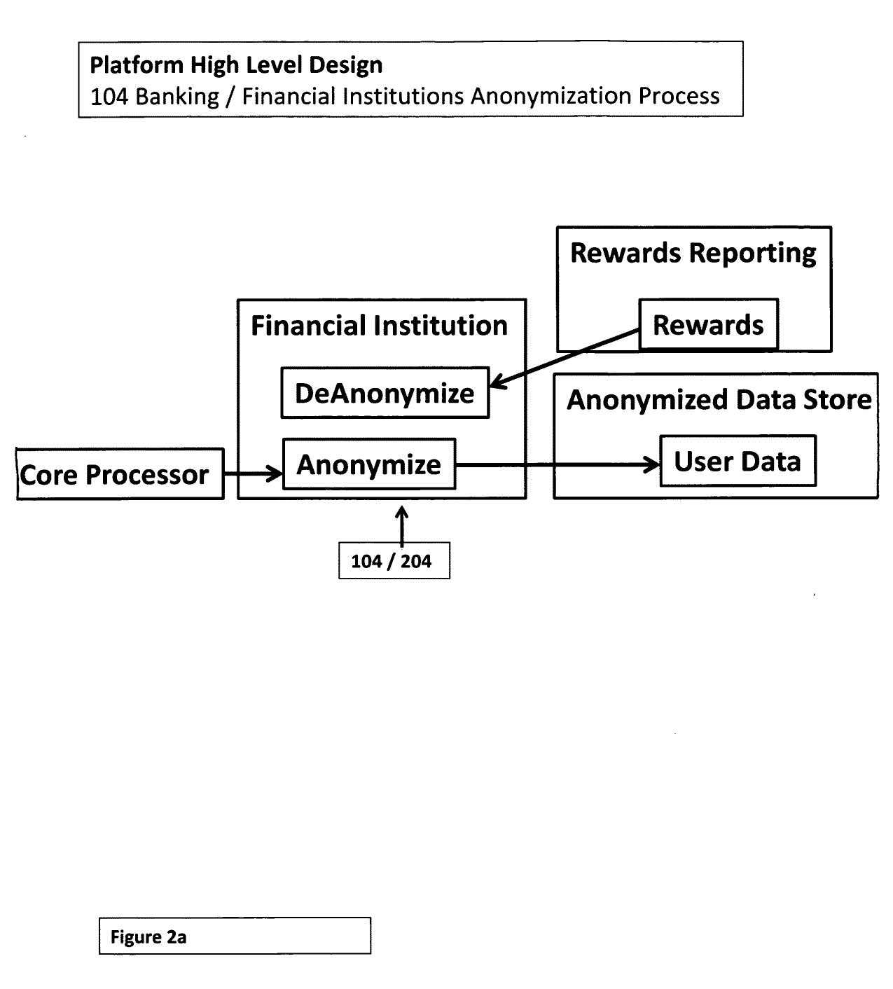

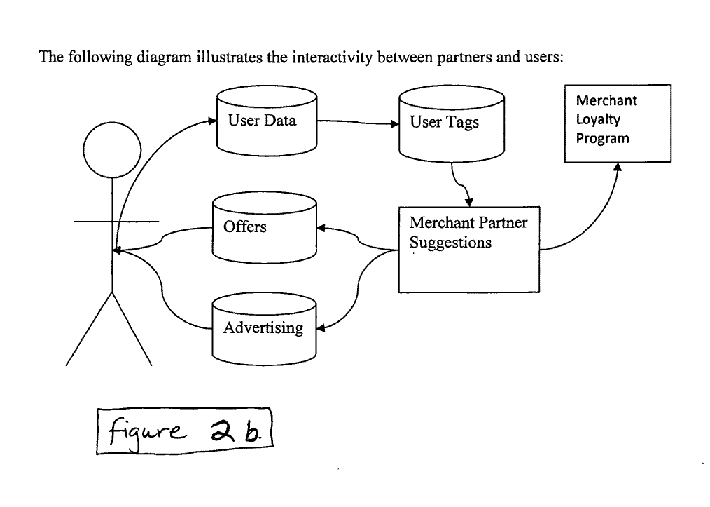

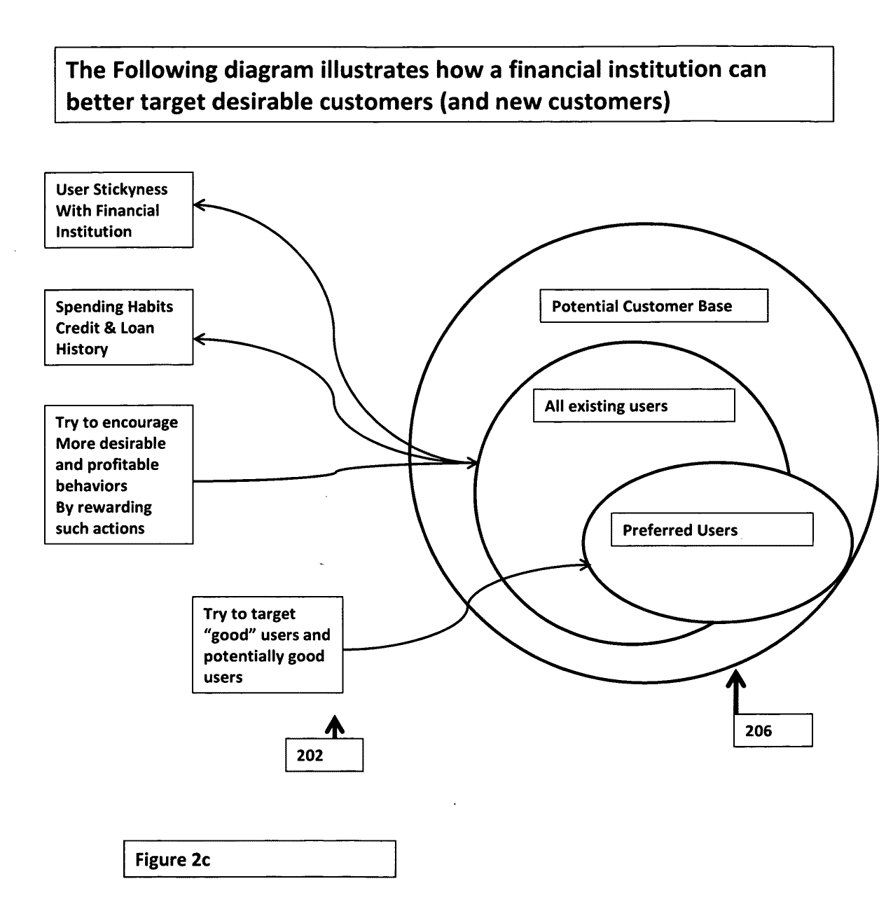

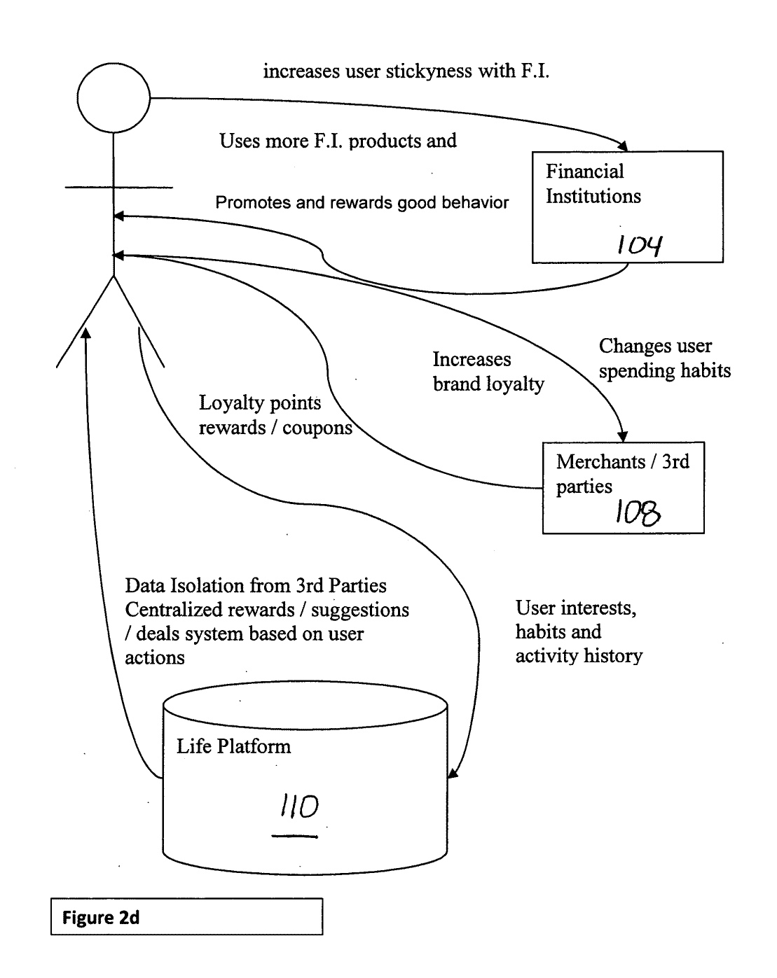

FIG. 2 shows the Product/FI/Partner Value Creation. The consumers 202, the financial institutions 204, and the partners 206 receive value 208 through the platform 110 as shown in the diagram.

As shown in FIG. 2a the Banking component 104 contains the Automated Inline Anonymization Transport Mechanism. This is an automated mechanism to ensure data is anonymzied before transfer from a financial institution to our servers. The banking component 104 also contains the Hybridized Content Delivery Process. This is a software mechanism that allows Financial Institutions to provide an authentication and customized portal for the customers that can run on the platform 110. It is used for customer login (and validating their anonymized credentials) and also for directly accessing a reskinned version of the bank that resides on our portal.

As shown in FIGS. 2b, 2c and 2d the platform provides capacity for personalized customer relationship building between the user and financial institutions 204. This is done by direct interaction to consumer via direct-to-call functionality (on website and phone) allowing customer to talk directly to a sales representative at the financial institution (allows financial institution to reach customers who cannot reach them). Financial institutions can tailor products to meet specific groups of consumers (micro targeting of products). Financial institution can passively market to users via a central place of interaction (user visits web/mobile portal and has passive, directed advertisements on the portal).

Financial institutions 204 can also reach new users via viral marketing based on positive feedback from existing users. FIG. 2d illustrates how a financial institution can better target desirable customers (and new customers). The relationship between customers 202 and partners 206 is bidirectional. Partners can provide deals to increase customer loyalty (or get customers from competitors) The platform can integrate with existing merchant loyalty programs. Partners can have direct marketing campaigns to users that meet their criteria.

Partners 208 can generate demographic reports on the consumer base and then outbound marketing campaigns to specific target groups. Cost to market is low (partners do not need to pay standard online advertising model, they pay per consumption). Partners benefit from a high probability of user interactivity due to user's being passively marketed to (offering rewards/benefits)

The main benefit of an all encompassing approach to providing data analysis and user targeted advertising/rewards is that both user and 3rd party can see the direct interchange and value add. The following diagram summarizes the benefits of having a centralized location to connect, extract and analyze user behavior for micro targeted advertising and benefits from 3rd parties

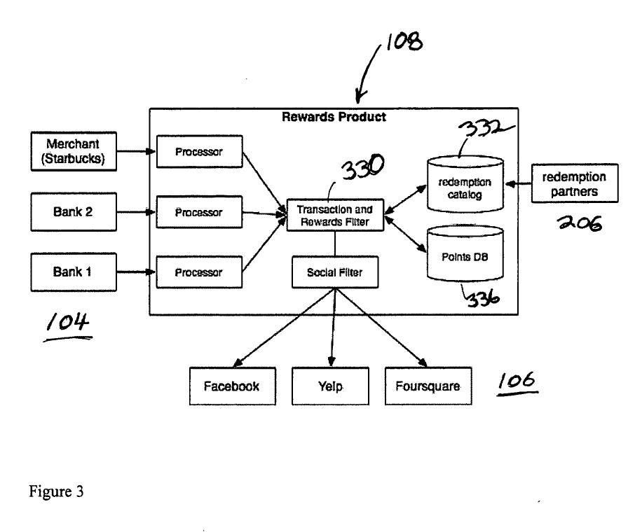

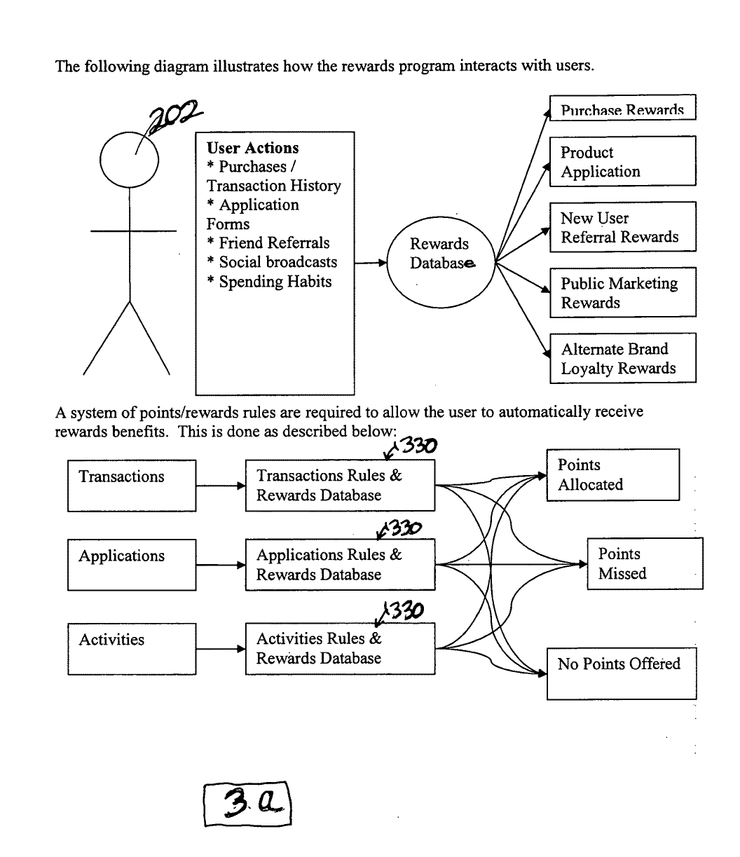

FIG. 3 shows the various external systems that the Rewards Product 108 of the platform 110 interacts with. Financial institutions 104 feed account and transaction information to the platform 110. Available customer rewards (e.g. gift cards) are stored into the redemption catalog (These are manually set up in the catalog currently). Then the platform 110 uses various social media systems 106 e.g. Facebook to allow users to post reward information, Yelp to display Merchant location information to the user.

Merchant may also set up reward offers in the platform 110. Software programs process a financial institution file into the platform 110 system. The platform 110 uses the Transaction/Rewards filter to store the information into the Points database. The transaction/Rewards filter 330 is the platform 110 software that contains the business logic. The Redemption Catalog 332 is a database containing available rewards e.g. gift cards. The points DB 336 is a database that tracks customers and their points. Redemption partners 206 are companies used for rewards e.g. B&N, Starbucks. Social media sites 106 such as Facebook are sites that a customer can post information to

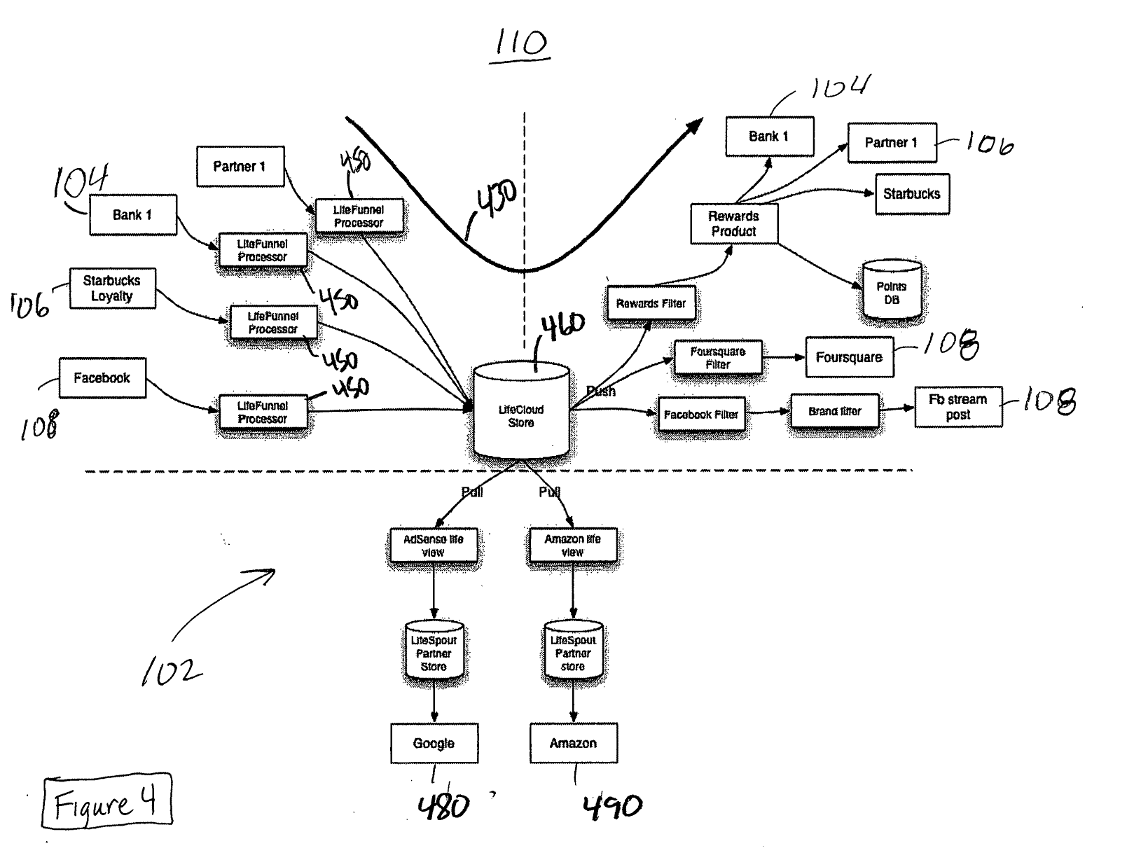

Reference is now made to FIG. 4, which depicts how all of the platform's 110 components are used in unison as part of the platform 110 to allow data to be imported, processed and then actioned upon in the form of rewards points to the consumer. The high level data flow 430 is shown. From the left, data flows in the platform 110 from the financial institutions 104, merchants 106, and social media 108. The data then flows through Processors 450. When a customer connects to social media site like Facebook, The platform 110 periodically pulls in the user's latest post for data mining purposes. All this information that comes in from the various external systems gets processed through the platform 110 into the platform database 460.

Then on the right, information gets pushed out to external systems 108. A customer can broadcast some recent purchase to their Facebook account. A customer can “check in” using Foursquare. When a customer does a reward redeem the bank is notified. A bank can also place a widget on their web site to display information from the platform 110.

On the bottom, it shows the platform 110 tying into Google 480 and Amazon 490. For Amazon, it would pull in a customer's purchase history to allow the platform 110 to make targeted offers to the customers. Or the platform 110 could provide Amazon, customer information so they could provide more targeted offers too. The same thing applies to Google.

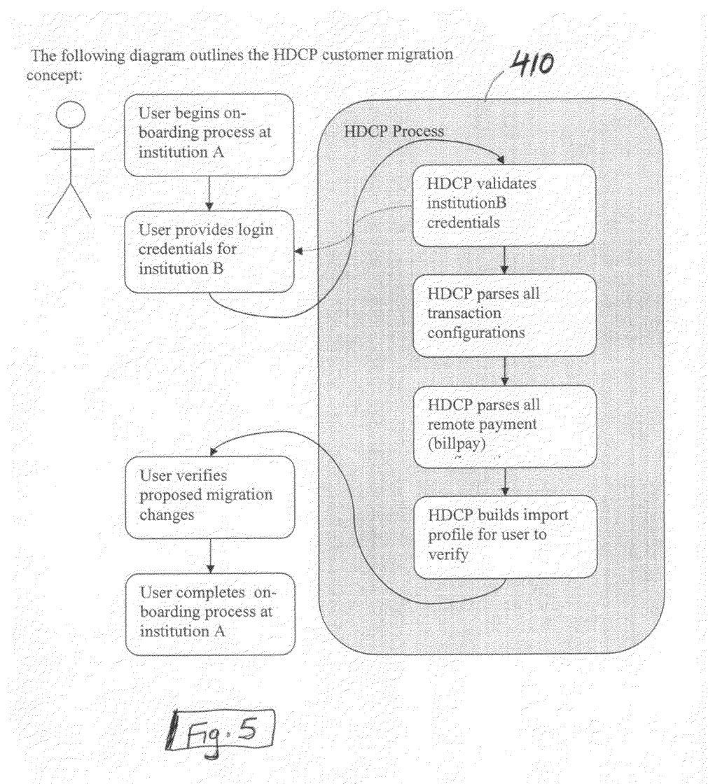

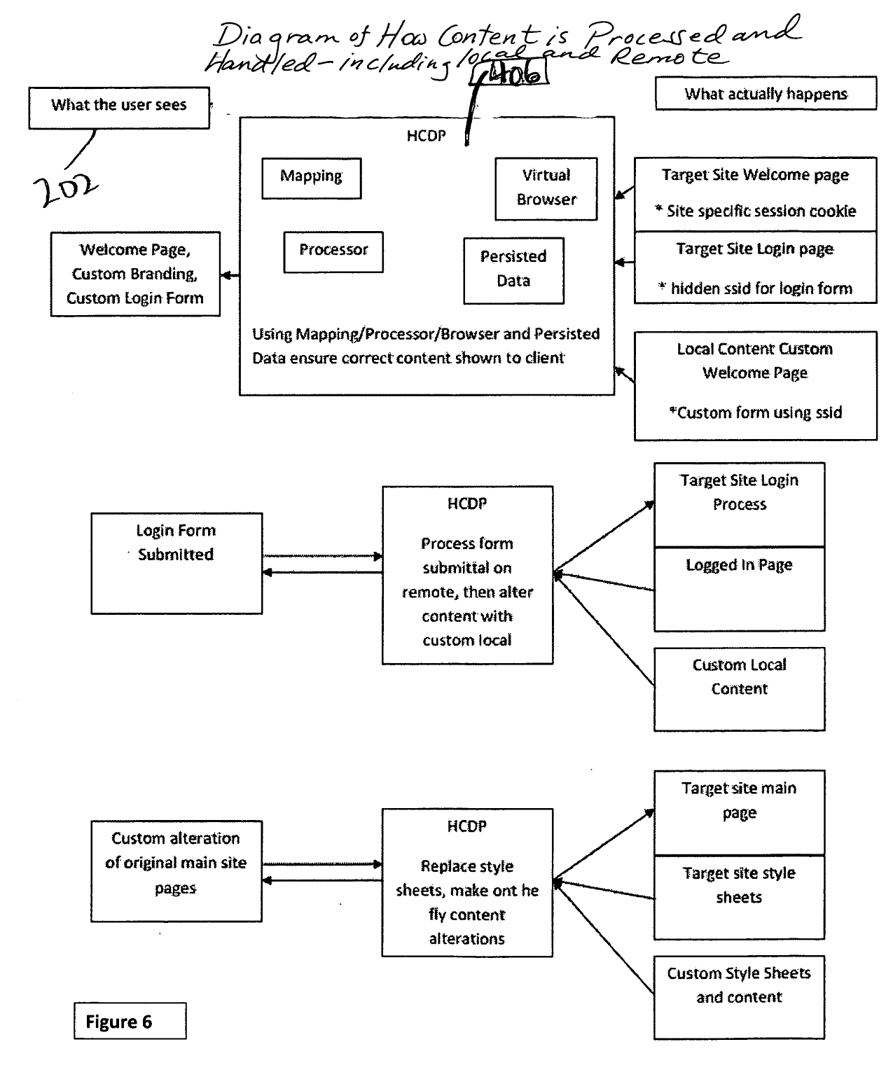

Reference is now made to FIGS. 5 and 6, which depict the Hybridized Content Delivery Process HDCP 410. The HCDP 410 is a computer system and method for leveraging an existing website interface and providing an interim client virtualization layer to allow the existing content to be utilized for purposes that were not originally scoped. The computer system facilitates hybridized content through functionality that allows it to dynamically alter content with new content (that is derived statically or dynamically from an alternate source).

The Hybridized Content Delivery Process system 410 is used to authenticate and provide permission for the platform 110 backend to have access to each of the feeds that are imported via the AITM 402. It is also used to provide Financial Intuitions such as banks 404 custom portals that are exposed within the rewards website. Third party data mining is also handled by the view interface of the ASARP system 408.

FIG. 5 outlines the HDCP customer migration. As mentioned in the HDCP description, the HDCP is designed to allow entities (such as financial institutions) leverage their existing web technologies for new purposes that were not part of the original design scope.

An extended use case for the HDCP is to allow a financial institution to migrate new customers from competing institutions. This process is not currently possible due to the complexities of bypassing competing bank firewalls, security protocols and then navigating and parsing their data structure.

Through utilization of all parts of the HDCP a financial institution is able to let a new customer connect to their previous financial institution, import all of the settings (for example automated bill payments) and then review the import and finally update their new bank account with these settings.

FIG. 6 shows that the platform integrates with partner financial institutions which provides their customer's account and transaction information. For customers who have a financial institution that is NOT integrated with the platform, this diagram describes how the platform would use screen scraping of that financial institution web site to retrieve the customer account and transaction information. The platform would log in as the customer to the financial institution web site and use the information retrieved to display the information on the platform web site.

The Action, Reaction, Suggestion and Analysis Platform 408 (ARSAP) system then analyses the incoming data. It then uses predefined rules to apply business logic on action and state data is it comes into the system. The business logic is used to apply/provide rewards points to the users 406.

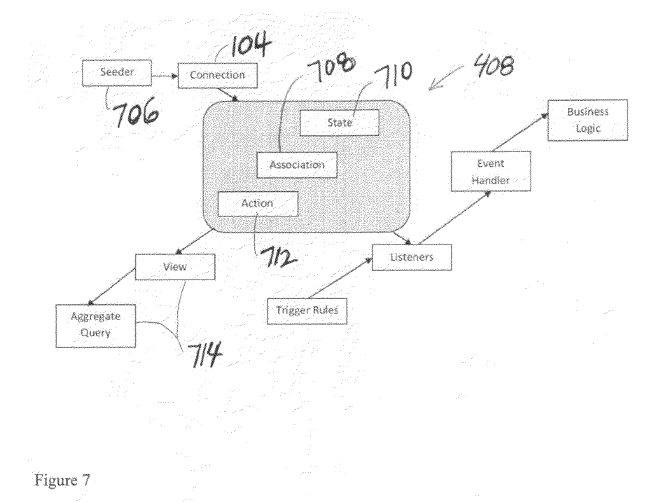

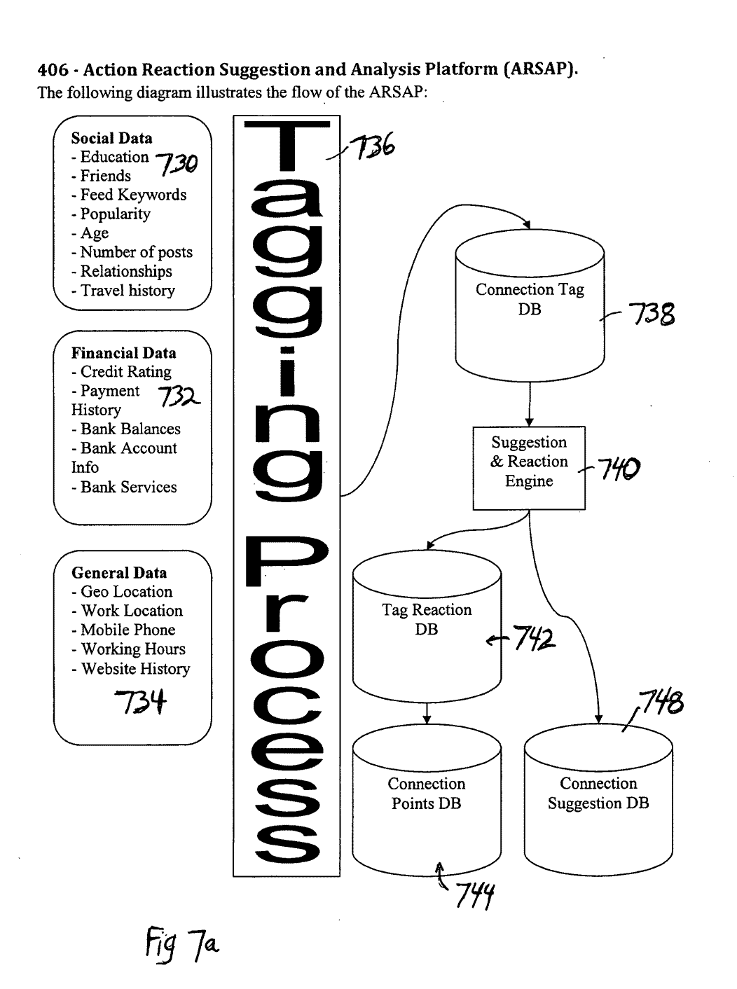

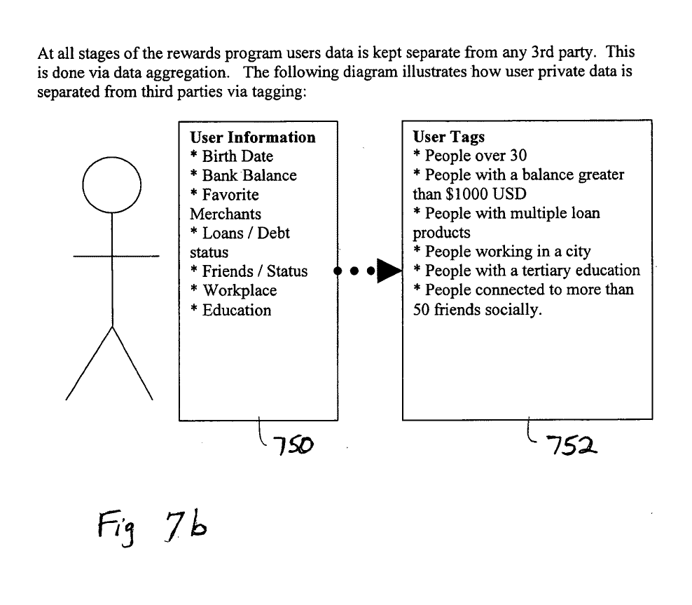

Reference is now made to FIGS. 7-9, which depict the Action, Reaction, Suggestion and Analysis Platform or ARSAP 408. The ARSAP 408 is a computer system for collating all available information about an individual in a manner that allows for deep utilization and cross referencing (including their friends' activities). The ARSAP 408 has a generic interface for connectivity to information providers and collates and stores imported data in a generic format. The ARSAP 408 triggers events as reactions to analysis rules of incoming data. Triggered events execute business logic on the information that caused the event to be triggered. Triggers can also be used to build a profile about the user so that the user can then receive recommendations that match their personal preferences or their social graph. The ARSAP 408 provides a dynamic view interface that allows live querying on an aggregated subset or the entire set of data that it contains.

FIG. 7 shows an internal view of the system of data and processes. The Seeder 706 processes a financial institution account file. The Connection 708 represents a financial institution 104. The Association 708 represents a customer's account which could be a financial institution checking account or a Facebook or some other website account. The State 710 is additional customer info pertaining to an Association 708. The Action 712 is activity regarding the customer's account or Association 708.

The View/Aggregate Query 714 is used to present different views of a customer's account or its activity (e.g. transactions). For the Actions 712 that occur, each one goes through a rules based engine that determines how it should be handled. This is handled by Trigger Rules 716, Listeners 718, Event Handler 720, and Business Logic 722.

FIG. 7a shows an example of the ARSAP process. Information from the user such as Social Data 730, Financial Data 732 and general data 731. The data is all sent through a Tagging process 736 and then sent to the Connection Tag Database 738. Then the Suggestion and Reaction Engine 740 processes the Connection Tag information to determine the Reaction, which is sent to the Tag Reaction DB 742, the Connection Points DB 744 and the Connection Suggestion DB 748.

FIG. 7b shows that As at all stages of the rewards program users data is kept separate from any 3rd party. This is done via data aggregation. FIG. 7b illustrates how user private data is separated from third parties via tagging. User information 750 is turned into user tags 752.

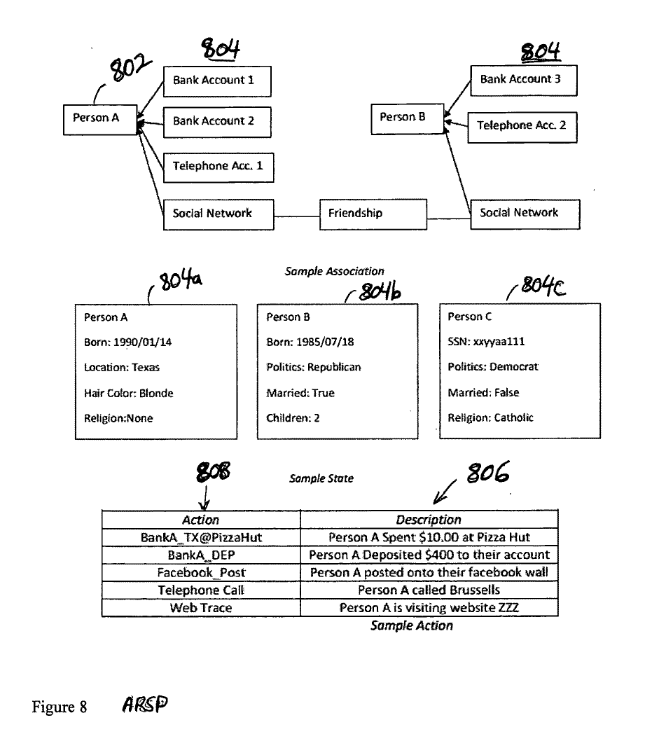

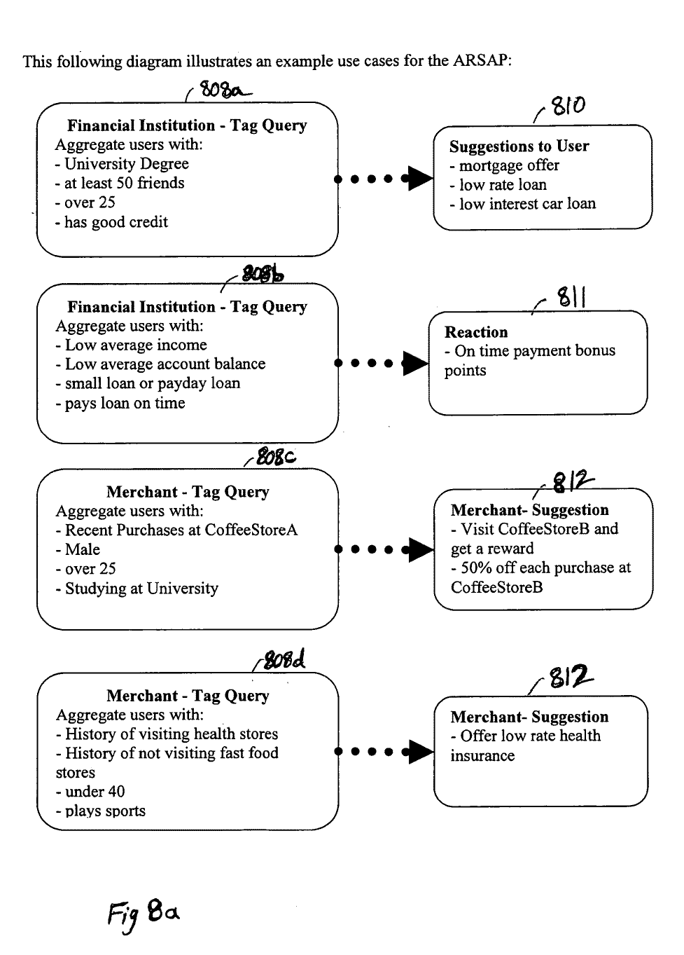

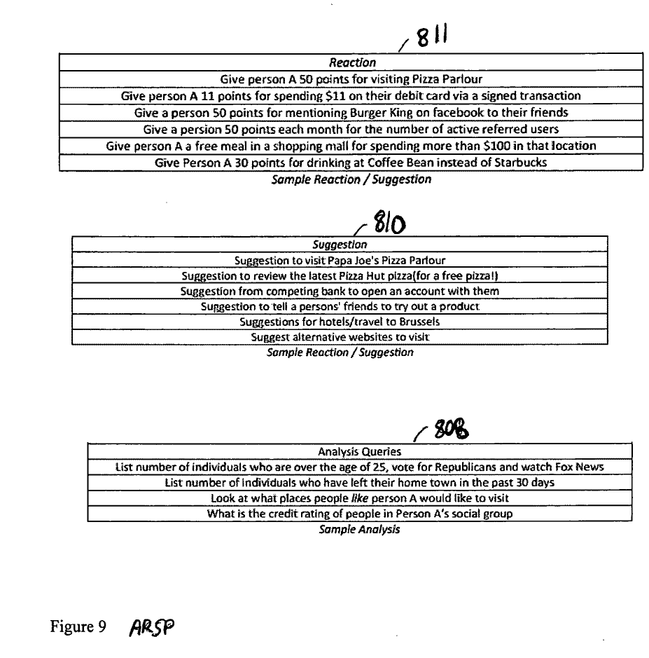

FIG. 8 Shows an example data snapshot of a customer 802. A customer 802 can have different Associations 804 that represent “accounts”. Each association 804 has additional information that is stored in State 806. The different events for each account are tracked through Actions 808.

FIGS. 8a and 9 illustrate the flow of the ARSAP. These steps and examples show how a customer can earn reward points for different types of events e.g. debit card transaction, posting info to Facebook, etc.

The Tag Querys 808 are input by merchants, and suggestions for users 810, reactions 811 or merchant suggestions 812 are output. Based on customer information, targeted suggestions can be presented to the customer. E.g., the customer posted to Facebook, that they are looking to buy a car. It can suggest a car loan from their financial institution.

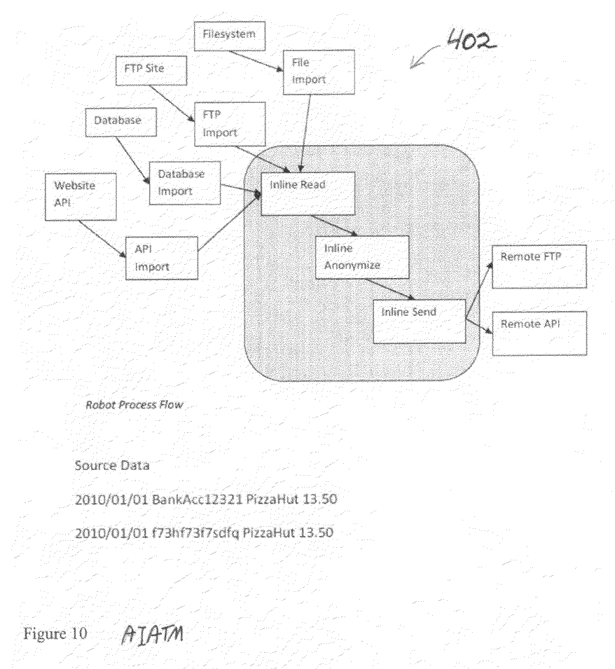

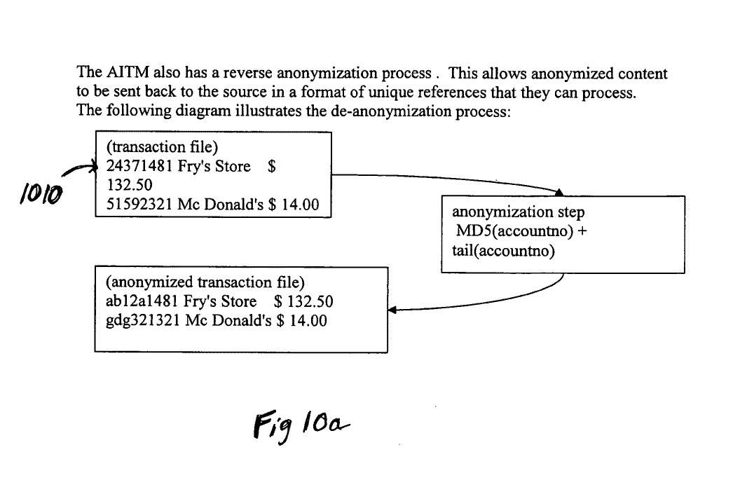

Reference is now made to FIG. 10, which depicts Automated Inline Anonymization Transport Mechanism or AIATM 402. The AIATM 402 is a system to allow export of highly private data from within a secured environment and send it out into an unsecured environment in a format that consists of a one way anonymization path that ensures no direct relation back to the individual entities that are related to the private data. The system has plugins to automatically poll source data locations for new content. The system uses a one way passphrase to anonymize data on the fly before it is uploaded to a target server.

In 402, data from a partner financial institution flows in the system. On the partner system, data (account/transaction information) can be retrieved (imported) from their internal systems (e.g. local file system, another server, a database). That data is anonymized or encrypted and is FTPd over as a file to the system or a web service can be used to send the data over.

The Automated Inline Anonymization Transport Mechanism (AITM) 402 system pushes data from 3rd parties such as banks 204. This information is then inserted and associated with platform users 202. As per FIG. 10 the Automated Inline Anonymization Transport Mechanism (AIATM) is shown. The AITM is a service that resides in a 3rd party (financial institution/merchant) establishment. It is a modular platform that is primary purpose is to facilitate anonymized data transfer between two entities.

As data passes through the AITM it is altered so that any user information that uniquely identifies an end user is anonymized so that it is the only party that can determine the relationship between a unique identifier on the input of the mechanism and the corresponding unique identifier of the output.

Anonymization involves a computation of a one way hash of the source information with a trailing 3 or 4 character (if needed) identifier that can be used by the owner of the data (i.e. the end user) to identify which piece of private data is being viewed (for example account numbers, SSN).

The AITM also has a reverse anonymization process. This allows anonymized content to be sent back to the source in a format of unique references that they can process.

The following diagram 10a illustrates the de-anonymization process. Asynchronous, distributed data store 1010 is a computer system that allows massive amounts of data to be stored in parallel databases to allow for faster retrieval and analysis. The system splits data into buckets that are related (by association) and then attempts to keep this data in a location that is relevant to the user that the data is associated to. The system then distributes redundant copies of this data into different storage areas to ensure back up in case of data failure. The system has a data access router that redirects data queries to the fastest available data source.

Although the invention has been described above with reference to several presently preferred embodiments, such embodiments are merely exemplary and are not intended to define the scope of, or exhaustively enumerate the features of, the present invention. Accordingly, the scope of the invention shall be defined by the following claims. Where a feature or limitation of a preferred embodiment is omitted in a claim, it is the inventors' intent that such claim not be construed to impliedly require the omitted feature or limitation.

We claim:

1. A software platform comprising:
a rewards component;
a banking component; and
a social media component.

2. The software platform of claim 1 wherein the banking component further includes input from banks and other financial institutions.

3. The software platform of claim 1 wherein the rewards component includes a processor, a transaction filter, a rewards filter, and a social filter.

4. The software platform of claim 3 wherein the social filter connects to social media sites.

5. The software platform of claim 4 wherein the rewards component uses input from the banking component to determine rewards.

6. The software platform of claim 2 wherein the social media component uses input from consumer transactions, financial products and offers to output to social media websites.

7. The software platform of claim 6 wherein the output to social media websites may be location based information, feeds or mobile phone based services.

8. The software platform of claim 1 and further comprising user data determined by the of the banking component.

9. The software platform of claim 1 and further comprising user data determined by the use of the social media component.

10. The software platform of claim 1 wherein the rewards component provides financial incentives based on data from the user.

11. The software platform of claim 9 wherein the user data comprises social data, financial data and general data that is used to input into a suggestion and reaction engine to determine suggestions and rewards.

12. A method of providing rewards comprising the steps of:
inputting user data into a software platform, the user data including input from banks and other financial institutions;
inputting user data into the software platform, the user data also including input from social media websites;
processing the user data using a transaction filter, a rewards filter, and a social filter; and
outputting rewards based on the user data.

13. The method of claim 12 wherein the user input is based on consumer transactions, financial products and offers to output to social media websites.

14. The method of claim 12 and further comprising the step of outputting information to social media websites.

15. The method of claim 14 wherein the output to social media websites may be location based information, feeds or mobile phone based services.

16. The method of claim 12 wherein the step of outputting rewards based on the user data further includes the step of providing financial incentives based on the user data.

17. The method of claim 12 wherein the user data comprises social data, financial data and general data; and the user data is input into a suggestion and reaction engine to determine suggestions and rewards.
